(19) United States
(12) Patent Application Publication
(10) Pub. No.: US 2018/0038971 A1
(43) Pub. Date: Feb. 8, 2018

(54) Seismic Source Installation/Anchoring System and Method

(71) Applicant: GreenPowerUSA Inc., Chatsworth, CA (US)

(72) Inventor: James K. Andersen, Woodland Hills, CA (US)

(73) Assignee: GreenPowerUSA Inc, Chatsworth, CA (US)

(21) Appl. No.: 15/594,469

(22) Filed: May 12, 2017

Related U.S. Application Data
(60) Provisional application No. 62/371,639, filed on Aug. 5, 2016.

(51) Int. Cl. G01V 1/09; B60D 1/58

(52) U.S. Cl. CPC G01V 1/09; B60D 1/58

(57) ABSTRACT

A vehicle hitch or tow bar can be used as an attachment point to a vehicle to provide weight to a seismic source system which includes at least one vibratory seismic source mounted to a shaft of pole and a mechanism for raising and/or lowering the shaft or pole for use in coupling a seismic source to the earth in conjunction with acoustic receivers for determining the lithology and for acoustic imaging of the subsurface of the earth.

### FIELD OF THE INVENTION

The invention relates generally to downhole seismic sources that are used in conjunction with acoustic receivers for determining the lithology and for acoustic imaging of the subsurface of the earth.

### BACKGROUND OF THE INVENTION

Seismic sources are used to introduce controlled acoustic waves into the subsurface such that the direct and/or reflected waves can be detected by sensitive sensors at the surface or downhole. The detected energy is typically collected and processed and used to develop images of the subsurface. These subsurface images are regularly used by oilfield companies to locate, monitor, and enhance the recovery from subsurface oil & gas deposits.

In general, there are two types of seismic surfaces used for exploration and production in a land oilfield, those placed on the surface and those place in the subsurface, i.e., downhole. The most widely used oilfield surface seismic source is the “vibroseis truck” which lowers a heavy plate onto the earth's surface which vibrates to radiate sound waves into the ground. The disadvantages of surface seismic sources such as the vibroseis truck include:
limited frequency bandwidth
relatively large size
difficult to use in non-level, rocky, or muddy terrain
high purchase price or high daily rental expense
surface signal is attenuated and filtered by the relatively “lossy” near-surface layers
can cause structural/vibrational damage to surroundings when used in populated areas

Downhole sources were originally developed to get away from some of the problems associated with surface sources, but downhole sources introduced problems of their own, namely:
limited power output (to prevent causing damage to well casings/cement bonds) thereby limiting transmission distance
difficult to achieve good acoustic coupling once lowered into position downhole
reliability issues associated with operating in rugged downhole environments that can include high temperatures and pressures
high cost of downhole equipment
not designed for permanent installation (most require periodic maintenance).

By an overwhelming percentage, the majority of onshore seismic surveys performed today employ surface seismic, that is, both the seismic sources and the seismic receivers are located at the surface.

### SUMMARY OF THE INVENTION

The present invention provides an improvement to the traditional system and method of coupling the seismic source to the earth where a heavy weight is used to hold a flat plate against the ground while the plate is subjected to vibration. It eliminates the heavy equipment/vehicles that are expensive and difficult to transport. It does this by using a seismic source system with at least one vibratory seismic source mounted to a shaft or pole, a means of raising and/or lowering the shaft or pole, and a means for attaching the seismic source system a motor vehicle or a trailer towable by a motor vehicle.

The seismic system can be a rotary vibrator, linear vibrator or a rotary vibrator system that produces linear vibratory motion, the seismic source can be a hydraulically-driven piston-reaction mass device where the shaft or pole has a stiff plate at the lower end and as the plate at the lower end of shaft or pole is lowered it eventually makes contact with the earth/ground while further lowering causes an increasing portion of the weight of a motor vehicle to be transferred to the shaft/plate. The means of raising and lowering the shaft or pole can be via one or more hydraulic or electrical actuators or a hand operated jacking system. The means of attaching the source system to a motor vehicle can be via a receiver trailer hitch that is affixed to the vehicle or a tow bar that is affixed to the vehicle. The seismic source can include an instrument for measuring and providing an indication of the force holding the bottom plate against the ground and include vibration isolators between the vibratory seismic source and the moveable shaft or pole.

### BRIEF DESCRIPTION OF THE DRAWINGS

FIG. 1 illustrates a system according to the present invention attached to the front of a typical pickup truck.

FIG. 2 illustrates a trailer hitch that can provide an attachment mechanism for use with the present invention.

FIGS. 3 and 4 illustrate to different possible configurations with some details of the present invention, FIG. 3 illustrating where the vibratory seismic source is located above an attachment point relative to a ground plate, FIG. 4 illustrating where the vibratory seismic source is located below an attachment point relative to a ground plate.

FIG. 5 is similar to FIG. 2, although it also illustrates use of a vibration isolator.

FIG. 6 illustrates a tow bar that can provide an attachment mechanism for use with the present invention.

### DETAILED DESCRIPTION OF THE INVENTION

For this invention a vibratory seismic source is mounted on a moveable shaft that is attached to the front or back of a standard pickup truck, sport utility vehicle, or other work vehicle preferably via a standard receiver trailer hitch. In the preferred embodiment, the vibratory seismic source/moveable shaft assembly are designed to be easily removable from the hitch assembly when not in use (i.e., highway traveling, etc.) The moveable shaft can be raised or lowered manually (similar to a car jack), via hydraulic actuator. The bottom of the moveable shaft includes a stiff plate, designed to provide the acoustic coupling to the earth. As the plate is lowered for operation of the seismic source, it will eventually contact the earth/ground. As it is lowered further, a portion of the weight of the vehicle will be transferred to the plate. Thus the weight of the vehicle provides the counterweight to ensure good seismic coupling with the earth. Once the desired amount of force is achieved, the position of the shaft will be locked in place, and the seismic source energized.

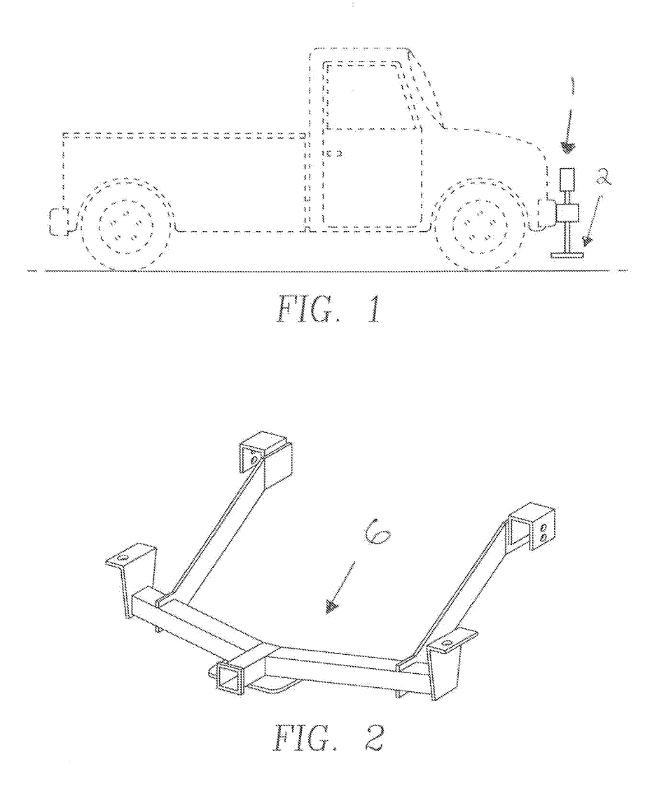

FIG. 1 illustrates a vibratory seismic source (labelled MicroVib™) mounted at the top of the moveable shaft. The source can be mounted at the top, bottom, or anywhere in-between on the moveable shaft. A front-mounted receiver trailer hitch provides the attachment method for the system to the vehicle. An example of such a hitch is shown in FIG. 2.

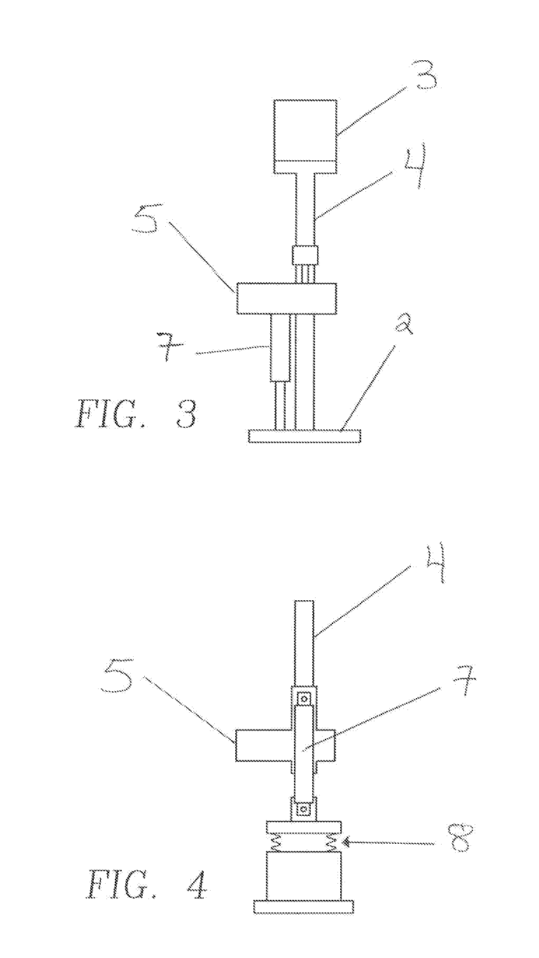

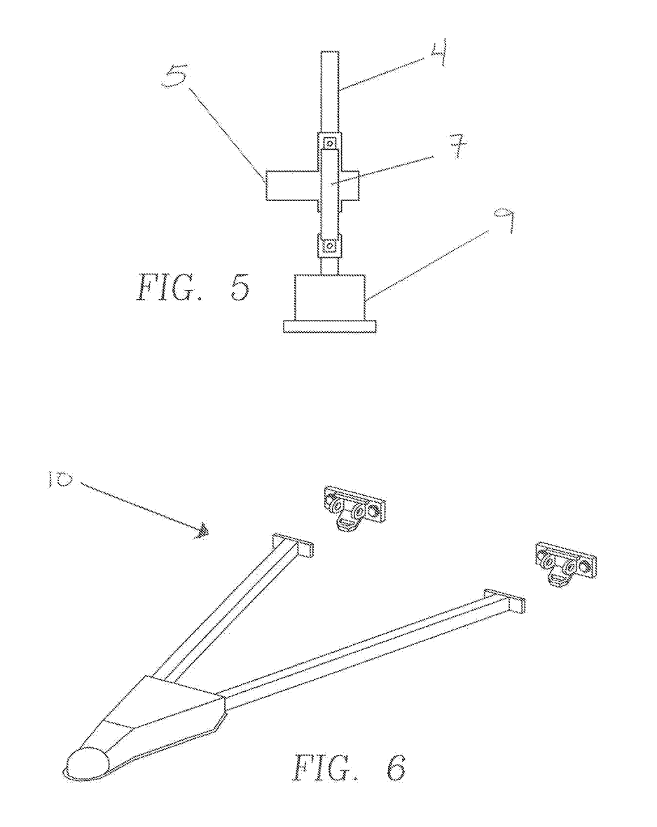

FIGS. 3 and 4 are possible configurations with some of the details of a system in accordance with the present invention. The locations for the seismic source, hydraulic actuator, etc., are provided as examples only. One skilled in the art realizes that they can be rearranged to multiple other locations without affecting the operation of the system. And, a hydraulic actuator system is shown, however, as stated previously, this represents just one possible means of moving the shaft. A receiver trailer hitch is an especially preferred method for attaching the system to a motor vehicle, however, another option is to use a tow bar at the front of the motor vehicle.

While the invention has been described herein with reference to certain preferred embodiments, those embodiments have been presented by way of example only, and not to limit the scope of the invention. Additional embodiments thereof will be obvious to those skilled in the art having the benefit of this detailed description.

Accordingly, it will be apparent to those skilled in the art that still further changes and modifications in the actual concepts described herein can readily be made without departing from the spirit and scoped of the disclosed inventions.

What is claimed is:

1. A seismic source system apparatus comprising:
at least one vibratory seismic source mounted to a shaft or pole;
a means of raising and/or lowering the shaft or pole; and
a means for attaching the seismic source system to a motor vehicle.

2. The seismic source system according to claim 1 wherein the seismic source is a rotary vibrator.

3. The seismic source system according to claim 1 wherein the seismic source is a linear vibrator.

4. The seismic source system according to claim 1 wherein the seismic source is a rotary vibratory system that produces linear vibratory motion.

5. The seismic source system according to claim 1 wherein the seismic source is a hydraulically-driven piston-reaction mass device.

6. The seismic source system according to claim 1 wherein the shaft or pole has a stiff plate at the lower end.

7. The seismic source system according the claim 6 wherein as the plate at the lower end of the shaft or pole is lowered it eventually makes contact with the earth/ground, and further lowering causes an increasing portion of the weight of the motor vehicle to be transferred to the shaft/plate.

8. The seismic source according to claim 6 further comprising an instrument for measuring and providing an indication of the force holding the plate against the ground.

9. The seismic source according the claim 1 wherein the means of raising and lowering the shaft or pole is via one or more hydraulic actuators.

10. The seismic source according to claim 1 wherein the means of raising and lowering the movable shaft or pole is via one or more electrical actuators.

11. The seismic source according to claim 1 wherein the means of raising and lowering the movable shaft is via a hand operated jacking system.

12. The seismic source according to claim 1 wherein the means of attaching the source system to a motor vehicle is a via a receiver trailer hitch that is affixed to the vehicle.

13. The seismic source according to claim 1 wherein the means of attaching the source system to a motor vehicle is via a tow bar that is affixed to the vehicle.

14. The seismic source according to claim 1 that includes vibration isolators between the vibratory seismic source and the moveable shaft or pole.

15. A seismic source system apparatus comprising:
at least one vibratory seismic source mounted to a shaft or pole;
a means of raising and/or lowering the shaft or pole; and
a means for attaching the seismic source system to a trailer towable by a motor vehicle.

16. A method, comprising the steps of:
creating an acoustic coupling between a ground surface and a stiff plate by mounting at least one vibratory seismic source to a movable shaft which is attached both to the stiff plate and to a movable structure; and
causing the movable shaft to move so that weight of the movable structure applies a force through the movable shaft to hold the stiff plate against the ground surface;
wherein the movable structure is comprised of a motor vehicle or an object towable by the motor vehicle.

17. The method of claim 16 wherein said at least one vibratory seismic source is not permanently mounted to the motor vehicle.

18. The method of claim 16, wherein said at least one vibratory seismic source is not mounted to the movable structure.
